(19) United States
(12) Patent Application Publication
(10) Pub. No.: US 2012/0223680 A1
(43) Pub. Date: Sep. 6, 2012

(54) LITHIUM ION AIR BATTERY

(75) Inventors: Hee Yeon Ryu, Uiwang (KR); Kyoung Han Ryu, Uiwang (KR); Sam Ick Son, Seoul (KR)

(73) Assignees: KIA MOTORS CORPORATION, Seoul (KR); HYUNDAI MOTOR COMPANY, Seoul (KR)

(21) Appl. No.: 13/151,716

(22) Filed: Jun. 2, 2011

(30) Foreign Application Priority Data
Mar. 3, 2011 (KR) 10-2011-0019103

(51) Int. Cl. H02J 7/00; H01M 12/06

(52) U.S. Cl. 320/137; 429/405

(57) ABSTRACT

The present invention provides a lithium ion air battery. The lithium ion air battery includes a lithium metal electrode, an air electrode and an intercalation electrode therebetween. The intercalation electrode is charged with lithium ions intercalated from the lithium metal electrode, and then used as an anode. The electric energy is generated from a reaction with the air electrode that is a cathode.

### CROSS-REFERENCE TO RELATED APPLICATION

This application claims under 35 U.S.C. §119(a) the benefit of Korean Patent Application No. 10-2011-0019103 filed Mar. 3, 2011, the entire contents of which are incorporated herein by reference.

### BACKGROUND

(a) Technical Field

The present invention relates to a lithium ion air battery having an intercalation electrode. More particularly, it relates to a lithium ion air battery that improves the to durability of a charge/discharge cycle and the safety of the battery by preventing formation of dendrite caused by repetitive charge/discharge cycles.

(b) Background Art

Due to the increasing public concerns related to environmental protection and pollution issues, there have been intensive studies on the development of alternative energy. Typical battery systems, as a field for developing alternative energy, may be roughly classified into lithium metal batteries and lithium ion batteries.

As shown in FIG. 1, a lithium metal battery, which uses a lithium metal 1 as an anode and allows an oxidation-reduction reaction in a cathode 2 during charge/discharge, has a large initial capacity and has a high theoretical energy density of about 5,200 Wh/kg. However, as charge/discharge is repeatedly performed, dendrite is formed on the surface of the metal as shown in FIG. 1 to reduce the charge/discharge capacity and efficiency, and the safety of the battery.

In order to overcome the above limitation, a lithium ion battery as shown in FIG. 2 has been developed. The lithium ion battery uses intercalation in which lithium ions are intercalated in a carbon material during charge/discharge by using a carbon material as an anode instead of lithium metal. Since the carbon material is used as the anode, the formation of the dendrite on the surface of metal is considerably reduced, thereby improving the safety and the charge/discharge efficiency of the battery.

Due to the lithium ion batteries popularity, considerable investment and to development of lithium ion batteries has been focused on their applicable to hybrid vehicles, plug-in hybrid vehicles, and electric vehicles. As a result of these developments lithium ion batteries have been applied to electric vehicles such as hybrid vehicles.

However, lithium ion batteries have energy densities much lower than those of lithium metal batteries (e.g., the theoretical value of Graphite/LiCoO2 is about 390 Wh/kg). According to the New Energy and Industrial Technology Development Organization (NEDO) in Japan, the energy density is expected to be a maximum of about 250 Wh/kg (e.g., theoretical energy density is about 570 Wh/kg, and the current level is about 120 Wh/kg). Also, the distance covered in one charge of a vehicle with the lithium ion battery seems to be still less than the distance of about 500 km that is the approximate distance which can be covered in one fuel filling of an internal combustion engine vehicle.

Particularly, since a typical lithium ion battery uses a carbon material anode, the discharge capacity may be considerably reduced compared to a lithium air battery using lithium metal as an anode.

Accordingly, a new battery for vehicles with a higher energy density exceeding that of a typical lithium ion battery is needed.

The lithium air battery as shown in FIG. 1, which is one of batteries for next-generation vehicles, is low priced and has a high energy density (about 5,200 Wh/kg). However, as described above, since the lithium metal 1 is used as an anode, there still exists safety concerns and durability issues wherein the charge/discharge cycle are reduced by dendrite generated during the repetitive charge/discharge cycles.

The above information disclosed in this background section is only for enhancement of understanding of the background of the invention and therefore it may contain information that does not form the prior art that is already known in this country to a person of ordinary skill in the art.

### SUMMARY OF THE DISCLOSURE

The present invention provides a lithium ion air battery, which includes an intercalation electrode containing lithium ions intercalated between a cathode (air electrode) and a lithium metal electrode, where lithium ions are charged in the intercalation electrode used as an anode through the intercalation of the lithium metal electrode, and an oxidation-reduction reaction is generated in the cathode.

In an illustrative embodiment, the intercalation electrode may include a mesh-type metal and an intercalatable material coated on both surfaces of the mesh-type metal. The intercalatable material can be any one of carbon material, graphite, silicon, tin, or lithium tin oxide (LTO).

In another embodiment, the interlayer electrode may be recharged with lithium ions through a circuit connection with the lithium metal electrode.

Other aspects and embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram illustrating the configuration and reaction mechanism of a typical lithium metal (lithium air) battery;

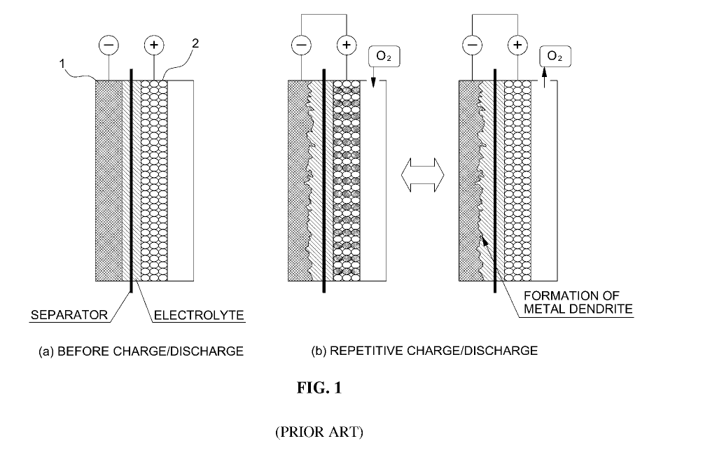

FIG. 2 is a diagram illustrating the configuration and reaction mechanism of a typical lithium ion battery;

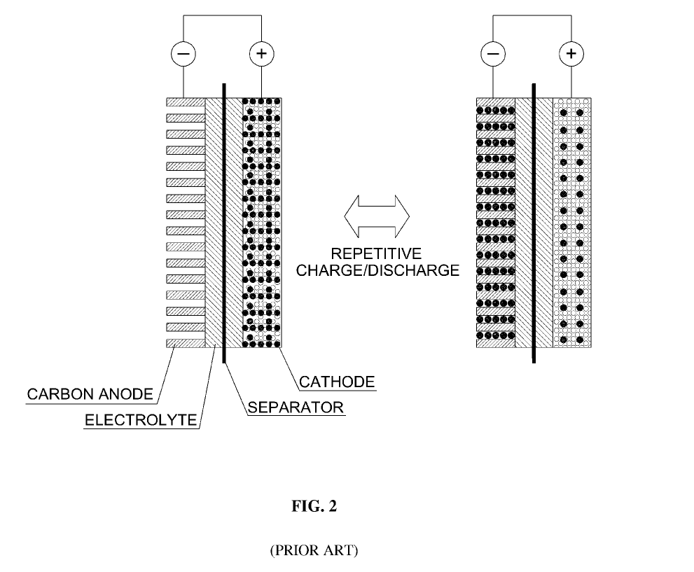

FIG. 3 is a diagram illustrating an initial state of a lithium ion air battery according to an exemplary embodiment of the present invention;

FIG. 4 is a diagram illustrating an initial state of a lithium ion air battery in which lithium ions are intercalated in an intercalation electrode according to an exemplary embodiment of the present invention; and

FIG. 5 is a diagram illustrating charge/discharge states of a lithium ion air battery according to an exemplary embodiment of the present invention.

Reference numerals set forth in the Drawings includes reference to the following elements as further discussed below:

1: lithium metal electrode

2: cathode (air electrode)

3: intercalation electrode

4: separator

5: electrolyte

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention relates to a lithium ion air battery, which includes an intercalation electrode containing lithium ions intercalated between a cathode (air electrode) and a lithium metal electrode, where lithium ions are charged in the intercalation electrode used as an anode through the intercalation of the lithium metal electrode, and an oxidation-reduction reaction is generated in the cathode.

Hereinafter, the present invention will be described in detail with reference to the accompanying drawings.

A lithium ion air battery according to an illustrative embodiment of the present invention includes a separator 4, an intercalation electrode 3, a separator 4, and a cathode to 2 that are sequentially stacked at both sides of lithium metal electrode 1, respectively, and electrolyte 5 is impregnated therebetween.

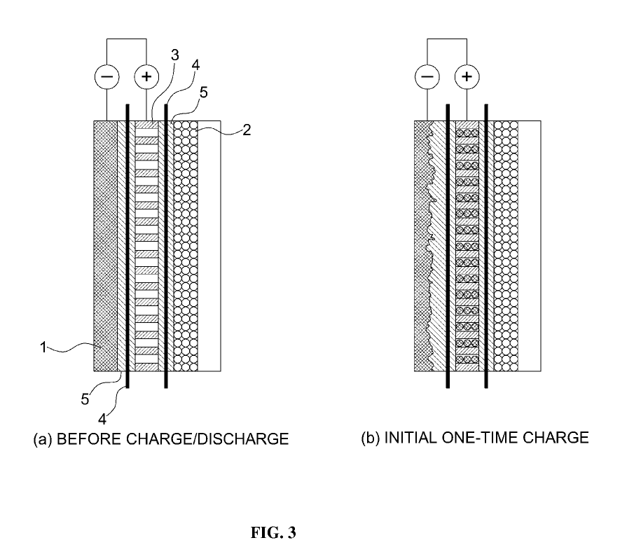

FIG. 3A illustrates an initial cell prior to regular charge/discharge (showing actual performance of a battery cell) after a battery cell according to the embodiment of the present invention is fabricated. In FIG. 3B, only the lithium metal electrode 1 and the intercalation electrode 3 of the initial cell are connected with an electrical circuit, and thus lithium ions of lithium metal are moved to the intercalation electrode 3 to be charged and stored through intercalation.

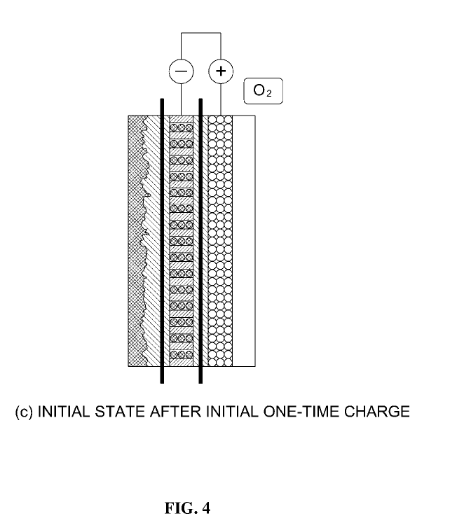

After the intercalation electrode 3 of the initial battery cell as shown in FIG. 3A is fully charged with lithium ions through an initial one-time charge, the electrical circuit between the lithium metal electrode 1 and the intercalation electrode 3 is short-circuited, and then the air electrode 2 and the intercalation electrode 3 charged with lithium ions as shown in FIG. 4C may be connected with an electrical circuit to be utilized as an actual battery.

In other words, since the intercalation electrode 3 is not charged with lithium ions at the initial stage of fabrication of the battery cell, electrical circuit can be connected between the lithium metal electrode 1 and the intercalation electrode 3 to allow lithium ions to move from the lithium metal electrode 1 that is the source of the lithium ions to the intercalation electrode 3 through the initial one-time charge, and then short the electrical circuit between the lithium metal electrode 1 and the intercalation electrode 3.

Thereafter, in order to show the performance of an actual battery cell, the air electrode 2 and the intercalation electrode 3 charged with lithium ions may be connected with an electrical circuit, and then a reaction is performed to generate electrical energy. In this case, the lithium metal electrode 1 is not used.

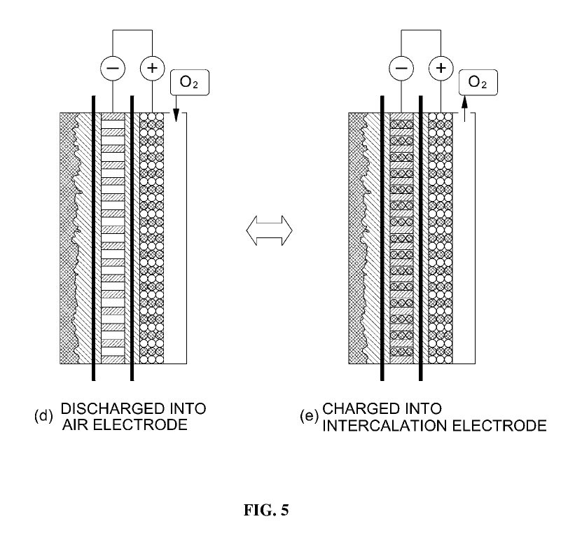

FIG. 4C illustrate an initial state of a battery cell including the intercalation electrode 3 intercalated with lithium ions, in which the connection between the lithium metal electrode 1 and the intercalation electrode 3 is short-circuited, and the intercalation electrode 3 and the air electrode 2 are connected via a circuit. In FIGS. 5D and 5E, repetitive charge/discharge may occur between the intercalation electrode 3 charged with lithium ions intercalated from the lithium metal electrode and the air electrode 2 that is the cathode.

When a battery cell of a lithium ion air battery according to the illustrative embodiment of the present invention operates, as shown in FIG. 5D, lithium ions may be discharged from the intercalation electrode 3 charged with lithium ions to the air electrode 2, and as shown in FIG. 5E, lithium ions may be charged from the air electrode 2 to the intercalation electrode 3. Such a charge/discharge cycle may be repetitively performed to generate electrical energy.

Also, as mentioned above, when the battery cell operates, the lithium metal electrode 1 is not used after an initial one-time charge of the intercalation electrode 3, but the utilization of lithium ions of the intercalation electrode 3 may be reduced due to the repetitive charge/discharge cycles of the battery cell. In this case, the lithium metal electrode 1 and the intercalation electrode 3 may be again circuit-connected to additionally charge the intercalation electrode with lithium ions.

That is, the lithium ion air battery according to the embodiment of the present invention may generate electrical energy through an intercalation reaction in the lithium metal electrode 1 during the initial stage and then through an oxidation-reduction reaction in the air electrode 2 during the charge/discharge.

Furthermore, the intercalation electrode 3 may be formed by coating both surfaces of an electrode metal forming and supporting the structure of the electrode with a material in which lithium ions can be intercalated. More specifically, the intercalation electrode may be formed using metal that can be used as an electrode to have a structure in which the bi-directional movement of lithium ions is possible, i.e., a mesh-type structure in which lithium ions charged from the lithium metal electrode 1 may move to the air electrode 2. Examples of the intercalatable material may include carbon material, graphite, silicon (Si), tin (Sn), and lithium tin oxide (LTO).

Particularly, since material for intercalation electrode, which includes silicon alloy, silicon oxide and tin, has a lithium ion charging capacity larger than carbon material or graphite, the intercalation electrode 3 using such a material may contain a large amount of lithium ions in order to increase the energy density of a battery.

Thus, the present invention provides a lithium ion air battery having a structure in which an electrode (intercalation electrode) is interposed between a lithium metal electrode and an air electrode to enable intercalation. The lithium metal electrode may be used only to charge the intercalation electrode with lithium ions one time at an initial stage. When a battery cell actually operates, the intercalation electrode 3 charged with lithium ions may be used as an anode rather than the lithium metal electrode. Accordingly, formation of dendrite can be prevented compared to a typical lithium air battery in which lithium metal is used as an anode. Also, safety and capacity during charge/discharge cycles can be improved to increase the durability of the charge/discharge cycle and the safety of the battery. In addition, the capacity of the air electrode is increased compared to a typical lithium ion battery, thereby improving the energy density as a result.

Accordingly, a lithium ion air battery according to an embodiment of the present invention can be expected to be applicable to electric vehicles requiring high energy and high durability, and particularly, can be expected to contribute the development of a new-generation electric vehicle having a mileage and durability level comparable to those of current internal combustion engine vehicles.

Hereinafter, embodiments of the present invention will be described in detail, but are not limited thereto.

### EXAMPLES

The following examples illustrate the invention and are not intended to limit the same.

A lithium ion air battery was fabricated using a lithium metal (Li metal foil, Hohsen Corp.) serving as a source of lithium ions, a cathode (air electrode) that is formed by coating a compound mixed with electrically conductive carbon (Ketjen Black EC-300J from Mitsubishi Chemical) of about 80%, a binder (PVdF from Kynar) of about 15%, and a catalyst (MnO from Aldrich) on a porous nickel foam, an intercalation electrode, which is formed by coating graphite (from Showa Denko) on both surfaces of copper metal having a mesh-type, inserted between the lithium metal and the cathode, an electrolyte (1M LiCF₃SO₃/0.5M LiTFSI+DME[1,2-Dimethoxyethane, anhydrous, 99.5%] from Aldrich), and a separator (glass fiber).

The lithium ion air battery that had been fabricated in the above manner generated electric energy by charging the intercalation electrode with lithium ions from the lithium metal at the initial stage (before charge/discharge for performance of a battery cell start), and then using the intercalation electrode as an anode of the lithium ion air battery for electro-chemical charge/discharge in association with the air electrode.

Even when an intercalation electrode fabricated using silicon alloy or tin alloy instead of graphite on the copper metal is used, electricity may be normally produced.

A lithium ion air battery according to an embodiment of the present invention can overcome relatively low energy density of a typical lithium ion battery, and generation of dendrite and reduction of capacity of a typical lithium air battery, and thus achieve significantly improved energy density compared to the typical lithium ion battery and improved safety and durability of the charge/discharge cycle compared to a lithium metal battery. Accordingly, the lithium ion air battery according to the embodiment of the present invention can be applied as a battery for electric vehicles requiring high energy and high durability.

The invention has been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A lithium ion air battery comprising
a lithium metal electrode;
an air electrode; and
an intercalation electrode impregnated between the lithium metal electrode and the air electrode, wherein the intercalation electrode is charged with lithium ions intercalated from the lithium metal electrode and then subsequently used as an anode, and electric energy is generated from a reaction with the air electrode as a cathode.

2. The lithium ion air battery of claim 1, wherein the intercalation electrode comprises a mesh-type metal and an intercalatable material coated on both surfaces of the mesh-type metal, and the intercalatable material selected from the group consisting of carbon material, graphite, silicon, tin, and lithium tin oxide (LTO).

3. The lithium ion air battery of claim 1, wherein the intercalation electrode is rechargeable with lithium ions through a circuit connection with the lithium metal electrode.

4. A circuit comprising
an air electrode electrically connected to an intercalation electrode to generate electrical energy from a reaction with the air electrode as a cathode,
wherein the intercalation electrode is impregnated between a lithium metal electrode and the air electrode, the intercalation electrode charged with lithium ions intercalated from the lithium metal electrode and then subsequently used as an anode.

5. The circuit of claim 4, wherein the intercalation electrode comprises a mesh-type metal and an intercalatable material coated on both surfaces of the mesh-type metal, and the intercalatable material selected from the group consisting of carbon material, graphite, silicon, tin, and lithium tin oxide (LTO).

6. The circuit of claim 4, wherein the intercalation electrode is rechargeable with lithium ions through a circuit connection with the lithium metal electrode.

7. A method for charging a lithium ion air battery comprising:
charging, initially, an intercalation electrode impregnated between a lithium metal electrode and an air electrode connected via a first circuit;
storing the lithium ions in the intercalation electrode;
short-circuiting the first circuit;
connecting the charged intercalation electrode to the air electrode via a second circuit which is not connected to the lithium metal electrode; and
using the intercalation electrode as an anode, and the air electrode as cathode to generate electrical energy via a reaction between the charged intercalation electrode and the air electrode.
